(19) United States
(12) Patent Application Publication
(10) Pub. No.: US 2024/0182378 A1
(43) Pub. Date: Jun. 6, 2024

(54) FERTILIZER WITH HIGH POTASSIUM TO LOW NITROGEN RATIO

(71) Applicant: PROFILE PRODUCTS L.L.C., Buffalo Grove, IL (US)

(72) Inventor: Edward ROSENTHAL, Sarasota, FL (US)

(73) Assignee: PROFILE PRODUCTS L.L.C., Buffalo Grove, IL (US)

(21) Appl. No.: 18/287,660

(22) PCT Filed: Apr. 20, 2022
(86) PCT No.: PCT/US2022/025585

§ 371 Date: Oct. 20, 2023

Related U.S. Application Data
(60) Provisional application No. 63/176,975, filed on Apr. 20, 2021.

(51) Int. Cl. C05G 3/40; C05B 17/00; C05G 5/30

(52) U.S. Cl. CPC C05G 3/40; C05B 17/00; C05G 5/30

(57) ABSTRACT

A controlled release fertilizer includes a plurality of prills, each prill within the plurality having a nutrient core including nitrogen (N) and potassium (K), and a coating structured to release nutrients from the core over a predetermined period of time, the plurality of prills having an overall ratio of N:K of about 1:8 to 1:2.

### CROSS-REFERENCE TO RELATED APPLICATIONS

This application claims the benefit of U.S. provisional application Ser. No. 63/176,975 filed Apr. 20, 2021, the disclosure of which is hereby incorporated in its entirety by reference herein.

### TECHNICAL FIELD

The present disclosure relates to a fertilizer, and more specifically a controlled release fertilizer, with high potassium (K) to low nitrogen (N) ratio, its production, and use as a feed for flowering plants.

### BACKGROUND

Numerous types of fertilizers have been identified and developed, some for specific types of plants. For example, liquid fertilizer feeds for orchids have been developed to serve the unique needs of the charismatic, colorful, fragrant, and economically important flowering orchid plants. The fertilizer feeds are typically water-soluble liquid fertilizers, which are commonly applied several times every week over a period of 12 to 18 weeks. The liquid fertilizers have been used by orchid growers to promote flowering. Yet, there is a need for a fertilizer for flowering plants which is more economical, efficient, more environment friendly, and which could be applied with lesser frequency.

### SUMMARY

In at least one embodiment, a controlled release fertilizer is disclosed. The fertilizer may have a plurality of prills, each prill within the plurality having a nutrient core including nitrogen (N) and potassium (K), and a coating structured to release nutrients from the core over a predetermined period of time. The plurality of prills may have an overall ratio of N:K of about 1:8 to 1:2. The fertilizer may also include one or more micronutrients. The fertilizer may be a single application fertilizer. The predetermined period of time may be about 30-360 days. Each nutrient core within the plurality of prills may have the same composition. Each prill within the plurality may have a ratio of N:K of about 1:8 to 1:2. At least some of the prills within the plurality may have a different ratio of N:K than 1:8 to 1:2. The fertilizer may have an N:P:K ratio of about 5-1-30.

In another embodiment, a controlled release fertilizer is disclosed. The fertilizer may include a mixture of controlled-release fertilizer prills having non-uniform composition, the mixture being structured to have a continuous release rate of K over a release period of about 30-360 days, the mixture having 2-8 times more K than N, based on the total weight of the mixture. Some prills in the mixture may be free of N, but include K. The mixture may include at least two different blends of prills, the blends having different N:P:K ratios. The mixture may include at least two different blends of prills, the blends having the same N:P:K ratios and having different release rates. The fertilizer may also include magnesium (Mg). The fertilizer may also include P in an amount of about 1/30 of K.

In yet another embodiment, a method of increasing flowering potential of a flowering plant is disclosed. The method may include adjusting an amount of available nutrients to a flowering plant by providing 2 to 8 times more K than N during a development stage of the flowering plant. The adjusting may include supplying a controlled release fertilizer having an overall ratio of N:K of about 1:8 to 1:2 to the flowering plant. The supplying may be completed via a single application of the controlled release fertilizer. The method may also include limiting the flowering plant's access to N until fruit bearing stage of the flowering plant's life. The controlled release fertilizer may also include magnesium, phosphorus, or both. The flowering potential may include increasing quality and quantity of the flower set of the flowing plant.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “substantially,” “generally,” or “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e. the range from 95 to 105. Generally, when the term “about” is used, it can be expected that similar results or effects according to the invention can be obtained within a range of +/−5% of the indicated value. The term “substantially” may modify a value or relative characteristic disclosed or claimed in the present disclosure. In such instances, “substantially” may signify that the value or relative characteristic it modifies is within #0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4, . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

As used herein, the term “and/or” means that either all or only one of the elements of said group may be present. For example, “A and/or B” means “only A, or only B, or both A and B”. In the case of “only A”, the term also covers the possibility that B is absent, i.e. “only A, but not B”.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The term “one or more” means “at least one” and the term “at least one” means “one or more.” The terms “one or more” and “at least one” include “plurality” as a subset.

The description of a group or class of materials as suitable for a given purpose in connection with one or more embodiments implies that mixtures of any two or more of the members of the group or class are suitable. Description of constituents in chemical terms refers to the constituents at the time of addition to any combination specified in the description, and does not necessarily preclude chemical interactions among constituents of the mixture once mixed. First definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

Flowering plants account for a large portion of agriculture, horticulture, and floriculture. Flowering plants are plants that bear flowers and fruit in angiosperms. Their seeds are enclosed within a fruit. There is a large diversity among the flowering plants as they encompass numerous genera and species and grow worldwide. Examples of flowering plants may be ornamental plants such as orchids as well as berry-fruit plants such as tomatoes or chile peppers.

The flowering plants require an intake of certain macronutrients and micronutrients for proper growth, flowering, and fruit production. More specifically, for proper growth and reproduction, it is desirable that the plant has an intake of certain micro- and macro-nutrients. It is not economical, feasible, or advantageous to provide a uniform source of the nutrients for the entire duration of the flowering plant's life. Specifically, the needs of the plant are different at different stages of its life. For example, while the roots are being developed, while the stem is growing, while the plant's stem is strengthening, while the leaves are growing, while the plant flowers are developing and opening, while the fruit is growing and ripening.

Since the flowering plants started to be cultivated, many different fertilization methods and ways have been introduced to aid in the flowering and fruit development. Yet fertilizers have historically come with benefits as well as a myriad of problems and issues. For example, fertilizers have contributed to algal blooms, surface water contamination, groundwater pollution, soil acidification, heavy metal contamination of soils, food contamination. Additionally, a traditional use of N—P—K (nitrogen-phosphorus-potassium) fertilizers has been suggested to cause decreasing concentrations of elements such as iron (Fe), zinc (Zn), copper (Cu), magnesium (Mg), and other trace elements in foods.

Hence, there is a need to develop a fertilizer which would address specific needs of a plant, encourage a flower set as opposed to plant growth, while being sustainable and with minimal negative impact on the environment and food production.

In one or more embodiments, a fertilizer is disclosed. The fertilizer may be at least partially a liquid, gel, or solid. The fertilizer may be encapsulated. The fertilizer may be a staged release or controlled release fertilizer (CRF). The fertilizer may be structured to release a predetermined amount of one or more nutrients only at predetermined times such that the plant receives different nutrients and/or different amounts of nutrients throughout the various stages of its life. The controlled release of the nutrients in a herein disclosed ratio may contribute to the plant morphology suitable for flowering of plants.

The fertilizer may be, include, comprise, consist of, or essentially consist of a single prill, a blend of prills, a mixture of prills. The prills may be uniform, non-uniform, have the same or different composition, configuration, shape, size, weight, porosity, and/or other properties.

The fertilizer may be a single application fertilizer. In other words, the fertilizer may be applied just once to achieve the desired result. Repeated application is not needed. Alternatively, the fertilizer may be applied more than once throughout the season.

The fertilizer may include one or more fertilizer prills. Some of the prills may be traditional fertilizer prills. At least some of the prills may be CRFs having a nutrient core and one or more coatings. The core may include a single type of nutrient. The single type of nutrient may include a macronutrient or a micronutrient. The fertilizer may include a blend of prills, each having the single type of nutrient. The fertilizer may thus include more than one type of nutrients, the nutrients being separated from one another within the individual prills of the blend. The fertilizer may thus include a blend of prills, the blend including prills with different types of nutrient cores. For example, the fertilizer may include a blend of prills having N cores, prills having K cores, and/or prills having P cores. The nutrients of the fertilizer being in a herein disclosed ratio.

The fertilizer may include one or more blends. The number and type of blends within the fertilizer may differ, for example depending on the specific species, growing conditions, environment, relative humidity, temperature, carbon dioxide concentration, light intensity, and/or other conditions. An example number of blends forming the fertilizer may be 2, 3, 4, 5, 6, 7, or more. The blends may include the same or different nutrient cores, coatings, or both. For example, at least two blends may include the same type of coating. In another example, at least two blends may include the same type of NPK ratios. In another example, a first blend may include a different NPK ratio than a second blend. In yet another example, a first blend may include NPK and one or more micronutrients while the second blend may not include any micronutrients. In a further example, the fertilizer may include a first blend having a first NPK ratio, a second blend having a second NPK ratio, and a third blend having a third NPK ratio. The first, second, and third blends may have the same or different coatings. At least two of the blends may include the same type of core having the same type of nutrients. The NPK ratios of the first and second blends may be the same while the NPK ratio of the third blend may be different. The release time period of the first, second, and third blends may be the same or different. In another example, at least one of the blends may be free of any N and P, but include K. The blend may be mixed with one or more additional blends including NPK in the same or different ratios to form the fertilizer.

Alternatively, or in addition, the core may include a mixture of nutrient types. The fertilizer may thus include a single type of prill, each prill having a core with more than one type of nutrient. For example, the fertilizer may include a number of cores, each core having N:P:K in the same ratio. It is contemplated that that the fertilizer could include a mixture of cores having NPK, but in different ratios, and/or including various sets of nutrients.

Alternatively still, the fertilizer may include a blend of cores having a single nutrient as well as cores having more than one nutrient within. For example, the fertilizer may include a first portion of N cores, P cores, and/or K cores as well as a second portion of cores having NPK.

The type of nutrient relates to macro nutrients and/or micronutrients including various elements such as nitrogen (N), phosphorus (P), potassium (K), calcium (Ca), sulfur (S), magnesium (Mg), boron (B), zinc (Zn), manganese (Mn), iron (Fe), copper (Cu), molybdenum (Mo), chlorine (CI), nickel (Ni), or their combination. Example compounds used as a source of the nutrients may include urea, potash, ammonium nitrate, ammonium phosphate, calcium phosphate, potassium sulfate, magnesium sulfate, etc.

The cores are encapsulated within one or more coatings. The one or more coatings may be structured to prevent release of the nutrients from the core until a predetermined time and/or prevent premature uncontrolled release of nutrients. The one or more coatings may be structured to enable release of the one or more nutrients from the core at a predetermined time, for a predetermined time period, at a predetermined release rate. The predetermined time/period/release rate may be the same or different for the one or more nutrients and/or prills.

For example, a first type of nutrient may be released at a first predetermined time and a second type of nutrient may be released at a second predetermined time, a third type of nutrient may be released at a third predetermined time, etc. The second predetermined time may be different than the first predetermined time than the third predetermined time. The first predetermined time may correspond to the root development stage of the plant. The second predetermined time may correspond to the stem growth of the plant. The third predetermined time may correspond to the flowering stage of the plant. Another predetermined time may correspond to the fruit formation, growth, maturing, or a combination thereof.

For example, a first type of nutrient may be released for the duration of a first predetermined period and a second type of nutrient may be released for a second predetermined period, a third type of nutrient may be released for a third predetermined period, etc. The first, second, and third predetermined periods may be the same, partially the same, partially different, or completely different from one another. The predetermined period may be the entire life cycle of the plant. The predetermined release time period may be a length of the growing season.

The release of the nutrients from the prills may be over a release time period determined by a release rate. The release time period may be about 30-360 days, 100-270 days, or 140-180 days. The release time period may be about 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, or 360 days. The release time period may be the same or different for each individual nutrient, core, blend, or a combination thereof.

The release rate may be regular, irregular, continuous, dis-continuous, calculated, predetermined. The release rate may be the same or different for each nutrient, core, blend.

The timed or controlled release may be realized by various mechanisms. A non-limiting example of a timed release mechanism in a CRF may be a release agent incorporated in a coating, one or more coatings structured to overlap to create a complicated path for the nutrients to leave the core, one or more coatings which are water impermeable or semi-permeable over a period of time, various degrees of porosity in the one or more coatings, etc.

The one or more coatings may include the same or different components. The core may be encapsulated in a single layer coating. Alternatively, a core may be encapsulated in a number of coating layers. The coating layers may include the same material. At least one of the coating layers may include different components than the remaining coating layers.

The coating(s) and/or coating layer(s) may include a biodegradable material, cellulose, polyurethane (PU), polyolefin (PO), polyethylene (PE), thermoplastic, thermoset. The coating may include one or more waxes. The waxes may form one or more wax-only layers or coatings. The waxes may be blended with another material such that at least one coating includes a wax-cellulose, wax-PU, wax-PE blend.

The fertilizer may be structured as a plurality of prills arranged to release nutrients over a duration of a specific time period. With flowering plants, the focus is on promoting the flowering, formation of the flower set, maintenance of the flower set, formation of fruit, development of fruit, or a combination thereof. To do so, it was discovered that altering the N:P:K ratio, and more specifically N:K ratio, of the fertilizer, increases the flowering potential of the flowering plants. Reducing the N available to the plant, especially in the first development stages, has also resulted in the plant focusing on the desirable development and/or maintenance of the flower set as opposed to a robust growth.

Traditional NPK fertilizers typically focus on balancing the N:P:K and/or N:K with ratios of about 3-1-2, 6-2-4, 9-3-6, 16-16-16, 10-10-10, 14-4-14, etc. To increase the plant's focus on producing flowers, as opposed to growing its roots, stem, and/or leaves, a fertilizer with a herein-disclosed N:K ratio may be implemented. Reducing the N is also more environmentally friendly and more economical while increasing K supports increased formation and/or maintenance of flowers. The disclosed N:K ratio was also found to encourage flower set and reduce plant stretching. The reduced plant stretching may contribute to increased rates of fertilization as the flowers are closer to one another. This may be especially beneficial for self-pollinating plants.

Because K is highly leachable, the one or more coatings may prevent its premature release from the prill. The coatings may also enable release of K from the prills over an extended period of time (such as 30 days or more) by preventing evacuation of a large amount of K from the cores at the same time, a problem not solvable with liquid fertilizers. The K may thus be preserved in the prill until a predetermined time for its release and/or partially released and partially preserved in the core for the entire duration of a desirable release period. The coating(s) may enable slow release of K at a predetermined rate for the duration of the predetermined release period. The slow controlled release may start from the beginning of the plant cycle such that the plant starts focusing on flowering as opposed to growth and strengthening of its structure. The slow controlled release may start at a later stage depending on the environmental conditions, plant species, grower's needs, etc.

The fertilizer may be structured to include a continuous release of at least one or more than one nutrient. The continuous release may include release of the at least one or more or more than one nutrient at the same or different rate. The continuous release may include continuous release of K. The continuous release may include a continuous release of N, P, K, and/or any other nutrients named herein. The continuous release may include a continuous release of N and K in the herein-described ratio for a release time period. The fertilizer may be thus configured to release the one more nutrients from the core in a controlled, predetermined manner.

The herein disclosed ratio of N:K may be about 1:8, 1:7.75, 1:7.5, 1:7.25, 1:7, 1:6.75, 1:6.5, 1:6.25, 1:6, 1:5.75, 1:5.5, 1:5.25, 1:5, 1:4.75, 1:4.5, 1:4.25, 1:4, 1:3.75, 1:3.5, 1:3.25, 1:3, 1:2.75, 1:2.5, 1:2.25, 1:2, 1:1.75, 1:1.5. 1:1.25, 1:1. As such, the fertilizer has about 2-8, 3-7, or 4-6 times more K than N. The fertilizer has about, at least about, at most about, or up to about 2, 3, 4, 5, 6, 7, 8 times more K than N, based on the total weight of the mixture. Some of the prills in the fertilizer may be free of or lack N.

Presence of P in the fertilizer is contemplated. The amount of P may be up to about, or at least about 5, 10, 15, 20, 25, 30 times lower than the amount of K. Non-limiting example NPK ratios may include ratios 5-1-31, 5-1-30, 5-1-25, 4-1-16, 3-1-12, 3-0-15, 2-1-4, 1-0-31, 1-0-8, 1-0-3, 1-0-2, etc.

The fertilizer may also include addition nutrients mentioned above. The additional nutrients may be included in separate prills, blends, cores, or be mixed in the prills, blends, cores of the fertilizer.

The fertilizer may be applicable to any type of flowering plant. The flowering plants may include Amborella, Bymphaeales, Austrobaileyales, Chloranthales, Magnoliids, Monocots, Ceratophyllum, or Eudicots. The flowering plants may be abiotic, self-pollinating, or biotic. Non-limiting examples of the flowering plants may include ornamental species such as orchids, poinsettias, chrysanthemums, azaleas; berry-forming plants such as strawberries, blueberries, blackberries, raspberries, tomatoes, chile peppers, bell peppers, eggplant, cauliflower, broccoli, cabbage, beans; grasses; daisy family species; rose family species; bromeliads; fruit trees; palms; aquatic plants such as water lilies; etc.

A method of preparing the fertilizer is disclosed herein. The fertilizer may be prepared by mixing one or more blends including K, considering various weight percentages of each blend. Non-limiting example blends to achieve these ratios may include CRFs having ratios of about 0-0-19, 0-0-22, 0-0-037, 0-0-047, 1-0-30, 1-0-31, 2-0-35, 2-0-38, 14-4-14, or the like such as any CRF containing K.

Alternatively, the fertilizer may be prepared by mixing prills having N cores with prills having K cores, and optionally prills having P cores, in the various weight percentages to achieve a blend of NPK in the herein disclosed ratios.

Further still, the fertilizer may be prepared by forming prills, each prill having a core having N, K, and/or P in the herein disclosed ratios. As a result, each prill in the fertilizer may have the desired ratio. The overall blend may also have the desired ratio.

The method of encouraging flowering of flowering plants is disclosed herein. The method also relates to reducing growth, undesirable growth, stretching of plants. The method also includes encouraging an increased robustness, quality, and/or quantity of a flower set, increasing length of the flower set maintenance, extending the length of the flowering stage, or a combination thereof. The method may include providing a flowering plant with an increased amount of K and/or reduced amount of N. The providing may include supplying a fertilizer such as the fertilizer described herein to the flowering plant. The fertilizer may have a ratio described herein, the ratio of increased K and decreased N compared to traditional fertilizers. The method may include restricting the flowering plant's access to N. The method may include increasing the flowering plant's access to K.

The method may include providing a herein described fertilizer to a flowering plant in one or more stages of plant's life. The stages may include seed, germination, growth, reproduction, pollination. The stages may include sprout, small plant, adult plant. The stages may include root growth, stem growth, leaf growth, flower set formation, flower set maintenance, fruit formation, fruit development, fruit maturing, fruit ripening. The method may include providing the disclosed fertilizer to the flowering plant during at least two stages, for example including the stage of seed, spout, small plant.

The method may include providing the disclosed fertilizer to the flowering plant continuously or discontinuously, regularly or irregularly.

The method may include exposing the flowering plant to an increased amount of K and/or decreased amount of N during the first stages of plant development. The first stages may include a time period in which the plant, under normal conditions, focuses on its growth. The method may thus include limiting the plant growth and instead focusing on forming a flower set, maintaining a flower set, or both.

The method may include limiting the plant's access to N. The limiting may include limiting the plant's access to N (besides a predetermined amount, for example an amount supplied via the fertilizer) until fruit bearing stage of the plant's life.

### EXAMPLE

### Example 1

A mixture of CRF prills was prepared for orchid growing. The mixture included a number of prills from two CRF fertilizer blends. The first and second blends included a first number of prills having a core including N, a second number of prills including a P core, and a third number of prills including the K core. The fertilizer included 25 wt. % of the first blend having a ratio of 14-4-14 and 75 wt. % of the second blend having a ratio of 2-0-38. Both blends had a release time period of 100 days, but the release time period may be different, for example 180 days. The resulting fertilizer had the NPK ratio of 5-1-31 with the K:N ratio being 6.2.

The fertilizer of Example 1 had the following composition:

| Type of Nutrient | Weight [wt. % ] | Total Weight [wt. %] |
|---|---|---|
| Nitrate N | 2.4 | |
| Ammoniacal N | 2.6 | |
| N total | | 5 |
| P total (P₂O₅) | | 1 |
| K total (K₂O) | | 31 |

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A controlled release fertilizer comprising:
a plurality of prills, each prill within the plurality having
a nutrient core including nitrogen (N) and potassium (K), and
a coating structured to release nutrients from the core over a predetermined period of time,
the plurality of prills having an overall ratio of N:K of about 1:8 to 1:2.

2. The fertilizer of claim 1, further comprising one or more micronutrients.

3. The fertilizer of claim 1, wherein the fertilizer is a single application fertilizer.

4. The fertilizer of claim 1, wherein the predetermined period of time is about 30-360 days.

5. The fertilizer of claim 1, wherein each nutrient core within the plurality of prills has the same composition.

6. The fertilizer of claim 1, wherein each prill within the plurality has a ratio of N:K of about 1:8 to 1:2.

7. The fertilizer of claim 1, wherein at least some of the prills within the plurality have a different ratio of N:K than 1:8 to 1:2.

8. The fertilizer of claim 1, wherein the fertilizer has an N:P:K ratio of about 5-1-30.

9. A controlled release fertilizer comprising:
a mixture of controlled-release fertilizer prills having non-uniform composition, the mixture being structured to have a continuous release rate of K over a release period of about 30-360 days, the mixture having 2-8 times more K than N, based on the total weight of the mixture.

10. The fertilizer of claim 9, wherein some prills in the mixture are free of N, but include K.

11. The fertilizer of claim 9, wherein the mixture includes at least two different blends of prills, the blends having different N:P:K ratios.

12. The fertilizer of claim 9, wherein the mixture includes at least two different blends of prills, the blends having the same N:P:K ratios and having different release rates.

13. The fertilizer of claim 9, further comprising magnesium (Mg).

14. The fertilizer of claim 9, further comprising P in an amount of about 1/30 of K.

15. A method of increasing flowering potential of a flowering plant, the method comprising:
adjusting an amount of available nutrients to a flowering plant by providing 2 to 8 times more K than N during a development stage of the flowering plant.

16. The method of claim 15, wherein the adjusting comprises supplying a controlled release fertilizer having an overall ratio of N:K of about 1:8 to 1:2 to the flowering plant.

17. The method of claim 16, wherein the supplying is completed via a single application of the controlled release fertilizer.

18. The method of claim 15 further comprising limiting the flowering plant's access to N until fruit bearing stage of the flowering plant's life.

19. The method of claim 16, wherein the controlled release fertilizer also includes magnesium, phosphorus, or both.

20. The method of claim 15, wherein the flowering potential includes increasing quality and quantity of the flower set of the flowing plant.
